(19) United States
(12) Patent Application Publication
(10) Pub. No.: US 2016/0091193 A1
(43) Pub. Date: Mar. 31, 2016

(54) CRYSTALLINE-GRAPHITIC-CARBON -BASED HYBRID THERMAL OPTICAL ELEMENT FOR LIGHTING APPARATUS

(71) Applicant: GE Lighting Solutions, LLC, East Cleveland, OH (US)

(72) Inventors: Dengke CAI, Willoughby, OH (US); Gary Robert ALLEN, Euclid, OH (US); Thomas CLYNNE, East Cleveland, OH (US)

(21) Appl. No.: 14/800,714

(22) Filed: Jul. 16, 2015

Related U.S. Application Data
(60) Provisional application No. 62/055,795, filed on Sep. 26, 2014.

(51) Int. Cl. F21V 29/89; F21V 7/22; F21K 99/00; F21V 29/77

(52) U.S. Cl. CPC F21V 29/89; F21V 29/773; F21V 7/22; F21K 9/1355; Y10S 977/742

(57) ABSTRACT

Provided is a lighting apparatus that includes a lighting source comprising a plurality of light emitting diodes (LEDs), one or more heat sink components dissipating heat generated by the LEDs, each heat sink component includes a first material layer, and a second material layer formed of a crystalline-graphitic-carbon-based composite comprising a crystalline-graphitic-carbon-based thermal optical element and a highly reflective optical coating combined together, and laminated with the first material layer.

### CROSS-REFERENCE TO RELATED APPLICATIONS

The present invention claims priority to U.S. Provisional Application No. 62/055,795 filed on Sep. 26, 2014, the entire contents of which are incorporated herein.

### TECHNICAL FIELD

The present invention relates generally to an optical structure for a lighting apparatus. In particular, the present invention relates a crystalline-graphitic-carbon-based hybrid thermal optical structure for a solid state light source.

### BACKGROUND

Commercial lamps which utilize incandescent, halogen, or high intensity discharge (HID) light sources must have relatively high operating temperatures, much higher than that of ambient air, in order to operate efficiently. As a consequence, heat egress is dominated by radiative and convective heat transfer pathways from the lamp to the ambient air or infrastructure.

For example, radiative heat egress scales with temperature raised to the fourth power, so that the radiative heat transfer pathway becomes super-linearly more dominant as operating temperature increases. In each of those high-temperature legacy lighting technologies, the light emitter is actually thermally insulated by the design of the light source in order to achieve the necessary high temperature, which may be about 3000 K in the case of an incandescent or halogen coil, and may be about 1000 K for the quartz or ceramic arc tube of an HID lamp.

Only the outer envelope materials, typically glass, must be held below their softening temperature, or a safe-handling temperature, thereby requiring some minimum surface area through which to dissipate heat via radiation and convection to the ambient. The required surface areas for heat dissipation from the envelopes have dictated the size and shape of the products based on those legacy light source technologies. This requirement has resulted in standards and regulations for the dimensions of the envelopes of those products.

Accordingly, thermal management for high-temperature legacy light sources—incandescent, halogen, and HID light sources—typically only requires meeting the standard dimensions (e.g. American National Standards Institute (ANSI) in the United States, and similar standards elsewhere), and providing adequate air space proximate the lamp for efficient radiative and convective heat transfer.

Thus, in order to achieve the desired operating temperature for these types of lamps, it is typically not necessary to increase or modify the surface area of the lamp to enhance the radiative or convective heat transfer.

As compared to incandescent, halogen, fluorescent, and HID lamps, solid-state lighting technologies such as light-emitting diode (LED) devices are highly directional by nature, as such devices typically emit light from only one side. But LED-based lamps are more energy efficient than incandescent or halogen lamps, for example, and typically have a longer operating life; and are becoming more efficient and longer-lasting than fluorescent and HID light sources, too.

In addition, LED-based lamps are durable, can operate under cold or hot temperatures, brighten quickly upon power-up, are dimmable, are ecologically friendly, and may utilize low-voltage power supplies. Due to the many advantages associated with LED-based lamps, designers have strived to design LED lamps as replacement lamps to replace conventional Edison-base incandescent and halogen light sources.

LED lamps typically operate at substantially lower temperatures than the high-temperature legacy sources, for device performance and reliability reasons. For example, the junction temperature for a typical LED device must be well below 200° C., and in most LED devices the junction temperatures are kept well below 150° C. or even lower. The Edison base is typically not thermally conductive enough to transmit more than about 1 watt of thermal energy, so most of the thermal energy of a multi-watt replacement lamp must be dissipated by radiation and convection to ambient air.

However, at such low operating temperatures, the radiative heat transfer pathway to the ambient air is so weak that convective heat transfer to the ambient air typically dominates. Thus, designers of LED light sources typically utilize a heat sink thermally connected to the LED light source to enhance especially the convective, and to a lesser extent also the radiative, heat transfer from the outside surface area of the lamp or luminaire.

A heat sink, in most general terms, is the thermal management subsystem that is part of the lamp or luminaire system, providing dissipation of the waste heat from the system into the ambient environment. As will be explained below, the usual means for dissipation in most LED replacement lamps, and in many LED luminaires and fixtures is a thermal management subsystem comprising two types of functional elements.

The first element (typically may be referred to as a thermal spreader) has a large cross-sectional area and high thermal conductance that efficiently conducts heat from the LED devices to the second element (typically may be referred to as a heat sink) that typically provides a large surface area for radiating and convecting heat away from the heat source in the LED lamp or luminaire to be dissipated to the ambient air.

In a typical design, the heat sink comprises a relatively large metal component having a large engineered surface area, for example by having heat fins or other heat dissipating structures associated with its outer surface. The large surface area of the heat fins provides efficient heat egress by radiation and convection to ambient air. In the case of very high-power LED-based lamps, designers have employed active cooling elements such as fans, synthetic jets, heat pipes, thermo-electric coolers, and/or pumped coolant fluid to enhance heat removal.

In the case of relatively low-power LED replacement lamps, the recent rapid gains in LED efficiency have enabled the design of lamps having fewer, smaller, or no heat fins, enabling a simpler, less expensive and aesthetically enhanced product design.

However, in the case of relatively high-power LED replacement lamps, e.g. to replace a 75 W or 100 W or higher wattage incandescent lamp in A-19 (2.4″ diameter) or A-21 (2.6″ diameter) sizes, heat fins are still typically required, with today's LED efficacies in the range of about 100 to 150 lumens-per-watt (LPW). As LED efficacies continue to improve to about 150 to 250 LPW, heat fins may not be required for 75 W and 100 W replacement lamps, but may still be required for 150 W and higher wattage replacement lamps in A-19, A-21 and A-23 (2.9″ diameter) sizes.

Furthermore, recent product development has occurred to replace high-wattage HID lamps, e.g. the 400 W metal halide lamp typically in an ED37 bulb (4.6″ diameter), and possibly eventually the 1000 W and 1500 W metal halide lamps typically in a BT56 bulb (7″ diameter), which may require either heat fins, or active cooling, or both, in order to dissipate the waste heat within the regulated dimensions of the lamp envelope, even as LED efficacies reach their eventual maximum values of about 200 to 250 LPW.

Another design challenge associated with solid-state lamps is that, unlike an incandescent filament, an LED chip or other solid-state lighting device typically cannot be operated efficiently using standard 110V or 220V alternating current (A.C.) power. Thus, on-board electronic components are typically provided to convert the A.C. input to direct current (D.C.) power for driving the LED chips.

Such electronic components are typically included within the lamp base (below the heat sink component) or in another internal chamber within the lamp or luminaire system, in contrast to the simple Edison base used in conventional incandescent lamps or halogen lamps. The on-board electronic components are typically about 80%-95% efficient, and so they generate heat in addition to the heat generated by the LEDs. Furthermore, the on-board electronic components are thermally sensitive and often must be kept even cooler than the LEDs, so that they too must be thermally connected to a heat sink to dissipate the heat to the ambient or the infrastructure.

Another design challenge associated with solid-state lamps is that the materials used in the thermal management system must have very high thermal conductivity, k [W/m-K] in combination with a sufficient material thickness to provide a high conductivity thermal path from the LEDs to the ambient. For example, if aluminum (Al, k˜80-200 W/m-K) is selected for the thermal spreader and/or the heat sink, the thickness might typically be about 1-2 mm; if a thermally-conductive polymer (TCP, k˜10-50 W/m-K) is used, the thickness might typically be >2 mm. The result is that the thermal management components may be very heavy and very expensive.

Accordingly, designers of LED replacement lamps (to replace, for example, conventional legacy incandescent A19-type light bulbs and/or parabolic aluminized reflector (PAR) and/or bulged reflector (BR) and/or multi-faceted reflector (MR) and/or decorative type lamps and/or HID lamps) must balance thermal management principals, such as regulated lamp size constraints, lamp power balance and lamp thermal impedance, and also consider cost, weight, and aesthetics (the shape, size and color characteristics of the LED lamp). In particular, LED replacement lamps have been designed to match legacy lamps in size and shape, in unlit appearance, in lit appearance (i.e., no LED dots), in beam distribution, and in color quality.

As mentioned above, a challenging aspect of LED lamp design for a replacement LED lamp that will be used in an Edison socket is managing the waste heat from the LEDs due to the regulated size constraints of the lamp and the insufficient thermal conductance of the Edison base. Thus, a need exists for methods and apparatus to efficiently, inexpensively, and aesthetically manage the waste heat from the LEDs of an LED replacement lamp.

### SUMMARY OF THE EMBODIMENTS

Given the foregoing deficiencies, a need exists for methods and systems configured to provide a crystalline-graphitic-carbon-based thermal optical element for a lighting apparatus (e.g., an LED lighting apparatus).

In one exemplary embodiment, a lighting apparatus is provided. The lighting apparatus includes a lighting source comprising a plurality of LEDs, a base portion housing electronic components for operating the lighting source, and a heat sink dissipating heat generated by the LEDs. The heat sink has one or more heat sink components having surfaces that may be in optical communication with the light emitted by the LEDs, and are in thermal communication with the ambient air or infrastructure, each heat sink component including a first material layer, and a second composite material layer formed of a crystalline-graphitic-carbon-based thermal optical element and a highly reflective optical coating combined together, and laminated with the first material layer.

In another exemplary embodiment, a method for forming a component of a heat sink in a lighting apparatus is provided. The method includes forming a heat sink component of the heat sink of a first material layer, forming a second composite material layer at a surface of the first material layer, the second composite material layer comprising a crystalline-graphitic-carbon-based thermal optical element and a highly reflective coating, combined together, and laminating the second material layer onto the first material layer.

The foregoing has broadly outlined some of the aspects and features of various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE DRAWINGS

FIG. 1 is a schematic illustrating a lighting apparatus that can be implemented within one or more embodiments of the present invention.

FIG. 2 is a schematic illustrating material layers of a heat sink fin of the heat sink of the lighting apparatus of FIG. 1.

FIGS. 3A and 3B are photographs of a front side and the back side of the crystalline-graphitic-carbon-based thermal optical material layer of FIG. 2.

FIG. 4 is a schematic illustrating a lighting apparatus that can be implemented within one or more other embodiments of the present invention.

FIG. 5 is a flow diagram for forming a heat sink fin of the heat sink of the lighting apparatus of FIG. 1.

FIGS. 6A, 6B and 6C are schematics illustrating allotropes of carbon including graphene (FIG. 6a), graphite (FIG. 6b), and nanotube (FIG. 6c), that can be implemented in accordance with one or more embodiments of the present invention.

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

### DETAILED DESCRIPTION OF THE EMBODIMENTS

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

Embodiments of the present invention provide a crystalline-graphitic-carbon-based thermal optical element for a lighting apparatus. The crystalline-graphitic-carbon-based thermal optical element may be implemented within the heat sink and/or optical component of a lighting apparatus to effectively dissipate heat in high lumen applications.

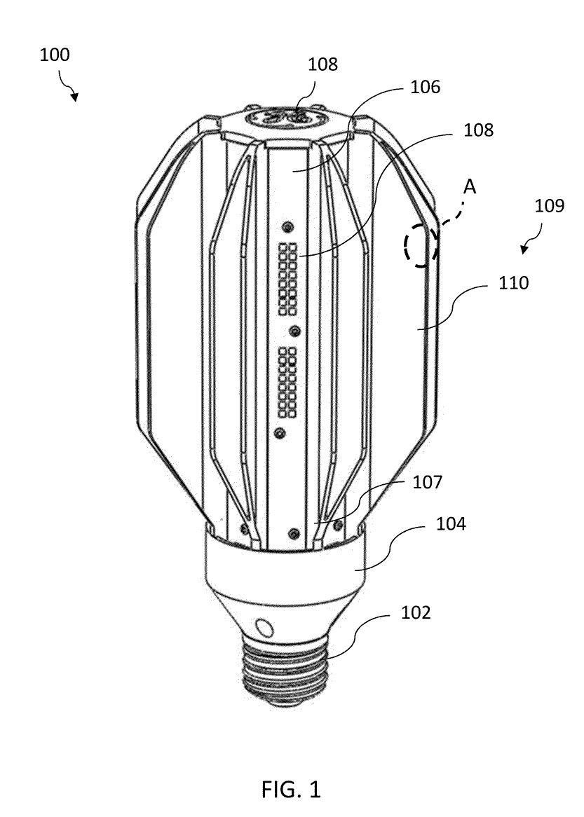

FIG. 1 is a schematic illustrating a lighting apparatus that can be implemented within one or more embodiments of the present invention.

The lighting apparatus 100 is an LED lamp according to one or more embodiments. The LED lamp 100 includes a base 102, a capper portion 104, a printed circuit board (PCB) 106 thermally attached to a thermal spreader 107, and a plurality of LEDs 108. The LED lamp 100 further includes a heat sink 109 having a plurality of heat sink components (e.g., fins) 110.

According to embodiments of the present invention, the base 102 is threaded for mating with a receptacle of a lighting fixture. The base 102 may be an Edison base (as depicted), a bayonet pin-type base or other suitable electrical connector.

The capper portion 104 houses the electronic components for operating the lamp 100. The electronic components include, for example, an LED driver and other suitable circuitry for operation of the LEDs 108.

The plurality of LEDs 108 are electrically and thermally connected with the PCB 106. Heat generated by the LEDs 108 is conducted through the PCB 106 and into a thermal spreader 107 on which the PCB 106 is mounted. The LEDs 108 may be bare semiconductor chips of inorganic or organic LEDs, encapsulated semiconductor chips of inorganic or organic LEDs, LED chip packages in which the LED chip is mounted on one or more intermediate elements such as a sub-mount, a lead-frame, or a surface mount support. The LEDs 108 may include a phosphor coating with or without an encapsulant, to cooperatively produce white light. LEDs 108 may be configured to collectively emit a white light beam based on the lighting application.

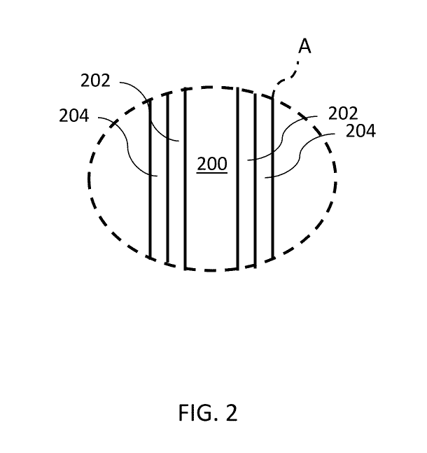

The thermal spreader 107 is in thermal communication with the heat sink 109 and the heat generated by the LEDs is dissipated via the heat sink fins 110 of the heat sink 109. Specifically, the thermal spreader 107 provides thermal communication from the LEDs 108 to the crystalline-graphitic-carbon thermal optical element layer (i.e., second material layer 202 depicted in FIG. 2) of the heat sink fins 110. The thermal coupling may be achieved by soldering, compression, thermally conductive adhesive or other suitable coupling structure or joining operation.

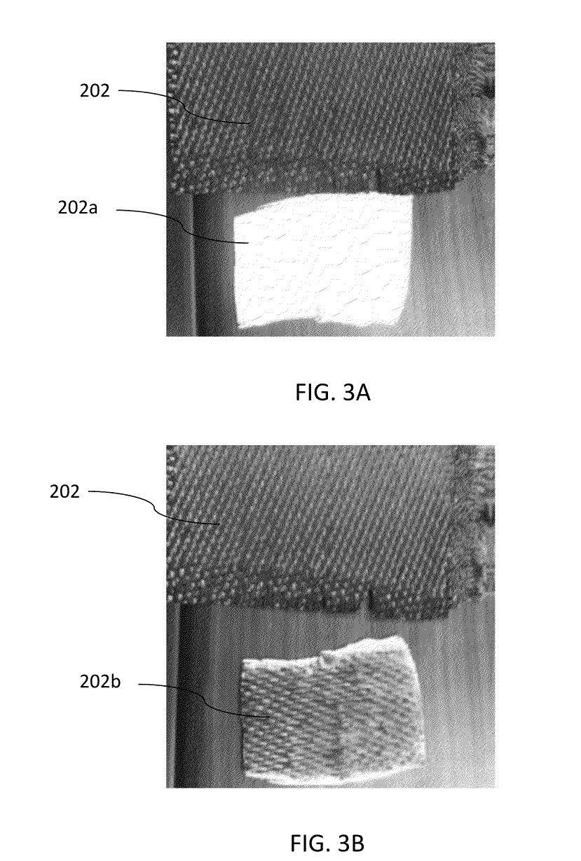

The heat sink 109 dissipates the waste heat to avoid damage to the lighting apparatus 100. The heat sink 109 comprises a plurality of heat sink fins 110 or other heat dissipating structures associated with its outer surface. In the embodiment of FIG. 1, the heat sink fins 110 extend latitudinally along a side surface a predetermined distance apart from each other between the capper portion 104 and a top surface of the LED lamp 100. The heat sink fins 110 enhance the radiative and convective heat dissipation. Details of the material layers (as depicted by ‘A’ in FIG. 1) of the heat sink fins 110 of the heat sink 109 will be discussed below with reference to FIGS. 2, 3A and 3B.

FIG. 2 is a schematic illustrating material layers of a heat sink fin 110 of the heat sink 109 of the lighting apparatus (LED lamp) 100 of FIG. 1 that can be implemented within one or more embodiments of the present invention. As shown in ‘A’ of FIG. 2, each heat sink fin 110 is formed of a plurality of material layers 200, 202, and an optional material layer 204.

The first material layer 200 forms the heat sink fin body which can be shaped or molded by casting resin and may include plastic or other polymer material such as polycarbonate (PC), poly(methyl methacrylate), nylon, polyethylene, epoxy resin, polyisoprene, sbs rubber, polydicyclopentadiene, polytetrafluoroethulene, poly (phenylene sulfide), poly(phenylene oxide), silicone, polyketone, or thermoplastics.

According to some embodiments, the first material layer 200 is a white highly reflective thermal plastic and a casting resin. According to other embodiments, the first material layer 200 may be formed of a thermally conductive material including for example, aluminum, copper, stainless steel, or another metal or alloy having an acceptable high thermal conductivity.

A second material layer 202 is formed of a thermally conductive, highly reflective material which is laminated as a pre-pregnated material with the first material layer 200. According to some embodiments, the second material layer 202 is a crystalline-graphitic-carbon-based composite and is continuously laminated along a surface area of the first material layer 200. Herein, crystalline graphitic carbon (CGC) is defined to include the various allotropes of carbon having trigonal carbon bonds forming fused hexagonal rings having enhanced thermal and electrical conductivity along the plane of the hexagon. CGC, herein, includes the hexagonal carbon allotropes including graphene, graphite, and nanotubes.

Graphene is the building block of these allotropes, theoretically comprising an infinite 2-D sheet of hexagonal rings of carbon atoms, one atom thick. Graphene is a 3-D stacking of two or more 2-D graphene sheets into a thicker sheet structure. A nanotube is a 1-D folding of the 2-D graphene sheet into a cylinder.

The acoustic and thermal properties of graphene, graphite, and nanotubes are highly anisotropic thermally, since phonons propagate quickly along the tightly-bound planes, but are slower to travel from one plane to another or out of the plane. They conduct heat extremely well along the plane and extremely poorly across the plane of the hexagonal bonds.

According to one embodiment, the crystalline-graphitic-carbon composite may include thermally conductive pitch-based carbon fibers which may be in the form of fibers, or yarn, or woven fabric, or non-woven mats, or other configurations that provide for orientation of the fibers along their thermally conductive axes.

A commercial example includes DIALED™ pitch-based carbon fiber fabric manufactured by Mitsubishi Plastics. The pitch-based carbon fiber (PCF) has a structure in which graphite plates are highly oriented in the axial direction of fiber. This results in such features as lightweight, high stiffness, high thermal conductivity, and ultra-low thermal expansion coefficient.

According to another embodiment, the crystalline-graphitic-carbon-based composite may include an array of thermally conductive carbon nanotubes. Carbon nanotubes (CNTs) are allotropes of carbon having a cylindrical nanostructure, and are characterized by extremely high thermal conductivity, typically ˜2000-5000 W/m-K. The CNTs are elongated tubular bodies that are typically only a few atoms in circumference.

Single-walled carbon nanotubes (SWCNT) having one tubule and no graphitic layers or multi-walled carbon nanotubes (MWCNT) having a central tubule and surrounding graphitic layers may be used. A commercial example includes non-woven sheets and mats manufactured by Nanocomp Technologies, Inc. In the rapidly emerging technology of CNT manufacturing, new types of CNT-based planar arrays may become available, which would provide additional anticipated embodiments.

According to another embodiment, the crystalline-graphitic-carbon-based composite may include a sheet of thermally conductive graphene. Graphene is an allotrope of carbon having a planar nanostructure, one atom thick, and is characterized by very high thermal conductivity, typically ˜1000-2000 W/m-K. A commercial example includes sheets and films manufactured by TheGrapheneBox.

The optional third material layer 204 is formed of a polymer transparent or translucent material. It may also be a coated fluorescent material for enhanced illumination purposes. According to one or more alternative embodiments, the third material layer 204 may be attached to the second material layer 202 such that the second material layer 202 is intrinsically laminated between the first material layer 200 and the third material layer 204. For example, the second material layer 202 (e.g., carbon fiber) may be laminated between white thermal plastics or inside white casting resins.

Additional details regarding the second material layer 202 will be discussed below with reference to FIGS. 3A and 3B.

As shown in FIG. 3A, according to one or more embodiments, the carbon nanotubes are dispersed by weaving single walled CNTs into a sheet of high thermal conductivity carbon nanotubes. The second material layer 202 is aligned to promote unidirectional performance of the crystalline-graphitic-carbon thermal optical element with the heat sink 109, to thereby maximize the thermal conduction behavior of the carbon fiber for heat dissipation. The carbon nanotube composite is thermally conductive and transparent and therefore does not affect the illumination pattern of the LED lamp 100.

Further shown, to avoid optical absorption from use of carbon, the second material layer 202 may be painted white with a powder coating on a front side 202a thereof opposite the side adjacent to the first material layer 200. As shown in FIG. 3B, the back side 202b facing the first material layer 200 remains unpainted or uncoated.

Typical thermal conductivity values of the first and second material layers 200 and 202, and density and thickness along each heat sink fin 110 are shown in Table below:

| | Thermal | | Thickness of |
|---|---|---|---|
| | Conductivity | | material on heat |
| Material | (W/m-K) | Density (g/cm3) | sink fin (mm) |
| Aluminum | 80-200 | 2.7 | 0.5-2.0 |
| Pitch-based Carbon | 100-800 | 1.55 | 0.14-0.28 |
| Fiber | | | |
| Graphene | 500-2000 | 1.5-2.0 | <<0.1 |
| CNT | 1000-5000 | ~2 | <<0.1 |
| White polymer | 0.2 | 1.2 | 0.5-2.0 |
| matrix (PC) | | | |

As shown in the Table above, the crystalline graphitic carbon of the second material layer 202 may be comprised of pitch-based carbon fiber having a thermal conductivity range between approximately 100 W/m-K to approximately 800 W/m-K, and the thickness of the material on the heat sink fin 110 may range from approximately 1.14 mm to approximately 2.28 mm.

As shown in the Table above, the crystalline graphitic carbon of the second material layer 202 may be comprised of graphene having a thermal conductivity range between approximately 500 W/m-K to approximately 2000 W/m-K, and the thickness of the material on the heat sink fin 110 may be much thinner than 0.1 mm.

As shown in the Table above, the crystalline graphitic carbon of the second material layer 202 may be comprised of nanotubes having a thermal conductivity range between approximately 1000 W/m-K to approximately 5000 W/m-K, and the thickness of the material on the heat sink fin 110 may be much thinner than 0.1 mm. If the first material layer 200 is formed of aluminum then the thermal conductivity of the layer is 80-200 W/m-K. According to some embodiments, the carbon-fiber is pitch-based carbon fiber composite having a thermal conductivity over approximately 300 W/m-K.

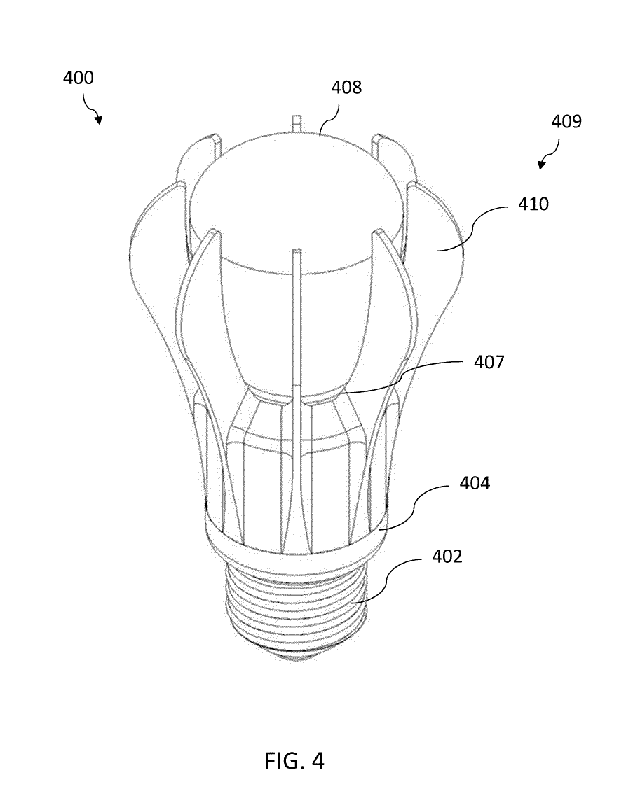

The second material layer 202 may also be applied to other components within a lighting apparatus as shown in FIG. 4. FIG. 4 is a schematic illustrating a lighting apparatus that can be implemented within one or more other embodiments of the present invention. The lighting apparatus 400 is similar to the lighting apparatus 100 shown in FIG. 1, therefore a detailed description of some of the components is omitted.

The lighting apparatus 400 is a LED replacement lamp of the A-line type, including a base 402, a capper portion 404, a thermal spreader 407 connected to LEDs, a diffuser 408, and a heat sink 409 having a plurality of heat sink fins 410 extending along a side surface of capper portion 404 and over the diffuser 408. The diffuser 408 is illuminated by an LED based light source arranged at an aperture along the top portion of the base portion 404.

The diffuser 408 includes a shell having a hollow interior and may be formed of glass or a transparent plastic for example. Alternatively, the diffuser 408 may be formed of a solid component including a light transmissive material such as glass or a transparent plastic.

According to an embodiment of the present invention, the thermal spreader 407 and/or the plurality of heat sink fins 410 may be coated on a top surface thereof with a crystalline-graphitic-carbon based composite same as the second material layer 202 of the heat sink fins 110 (as depicted in FIGS. 1 and 2). The crystalline-graphitic-carbon-based composite may be laminated to the material of the thermal spreader 407 and/or the plurality of heat sink fins 410. The crystalline-graphitic-carbon-based composite may further be coated with a white powder coating or white paint to enhance illumination.

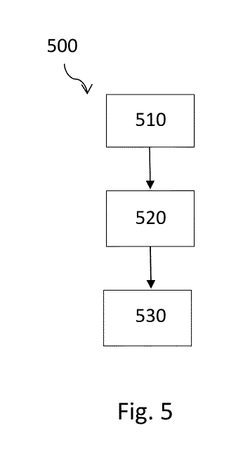

FIG. 5 is a flow diagram for a method 500 of forming a heat sink fin 110, 410 of the heat sink 109, 409 of the lighting apparatus 100, 409 of FIGS. 1 and 4 that can be implemented within one or more embodiments of the present invention. The method 500 begins at operation 510 where the heat sink body (or first material layer) is formed from a plastic or other polymer material.

At operation 520, a second composite material layer formed of a crystalline-graphitic-carbon-based thermal element and a highly reflective optical coating is laminated onto the first material layer. The composite is coated with a white paint or white powder prior to lamination. From operation 520, the process may continue to operation 530 where a third material layer formed of a thermal polymer material is disposed on the second material layer. According to embodiments, the second material layer may be intrinsically laminated between the first material layer and the second material layer.

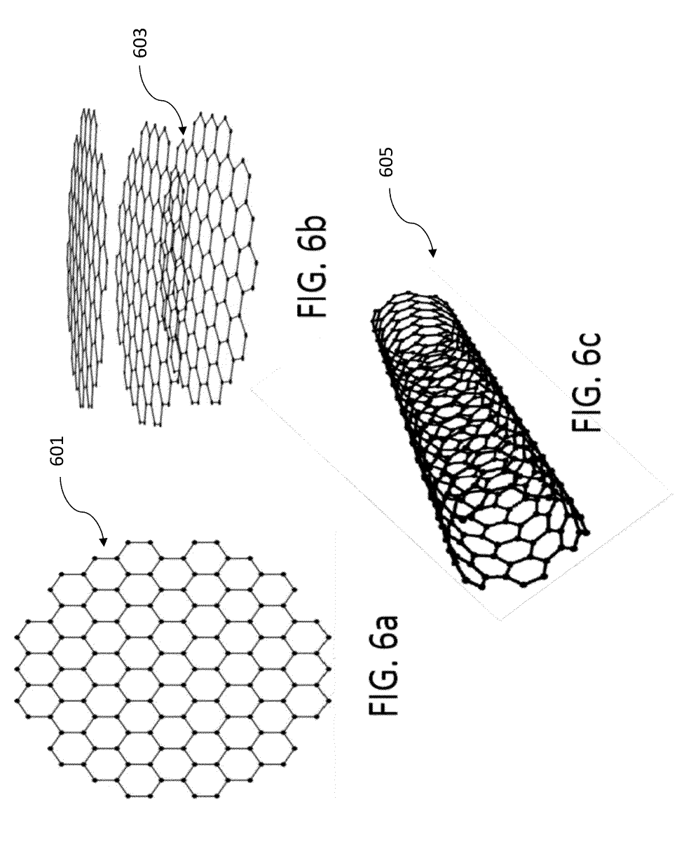

FIGS. 6A, 6B and 6C are schematics illustrating allotropes of carbon as discussed above, which can be implemented in one or more embodiments of the present invention. In FIG. 6A, graphene 601 is one allotrope of carbon which may be used. In FIG. 6B, another allotrope of carbon is graphite 603 and in FIG. 6C, yet another allotrope of carbon includes nanotube 605. These three allotropes of carbon provide thermal conductivity, k exceeding that of aluminum (˜200 W/m-K). The present invention is not limited hereto and may vary as necessary.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A lighting apparatus comprising:
a lighting source comprising a plurality of light emitting diodes (LEDs); and
one or more heat sink components dissipating heat generated by the LEDs each heat sink component comprising:
a first material layer; and
a second material layer formed of a crystalline-graphitic-carbon-based composite comprising a crystalline-graphitic-carbon-based thermal optical element and a highly reflective optical coating combined together, and laminated with the first material layer.

2. The lighting apparatus of claim 1, wherein the highly reflective optical coating comprises a polymer binder.

3. The lighting apparatus of claim 1, wherein the crystalline-graphitic-carbon-based composite is a high thermal conductivity hybrid material.

4. The lighting apparatus of claim 1, wherein the crystalline-graphitic-carbon-based composite comprises thermally conductive pitch-based carbon fibers.

5. The lighting apparatus of claim 3, wherein the second material layer is continuously laminated along a surface area of the first material layer.

6. The lighting apparatus of claim 5, the crystalline-graphitic-carbon-based composite comprises a thermally conductive carbon nanotubes composite.

7. The lighting apparatus of claim 1, further comprising a third material layer formed on the second material layer, wherein the third material layer comprises a transparent polymer material.

8. The lighting apparatus of claim 7, wherein the second material layer is intrinsically laminated between the first material layer and the third material layer.

9. The lighting apparatus of claim 1, wherein the highly reflective optical coating is formed of a white paint or white powder coating.

10. The lighting apparatus of claim 9, wherein the first material layer and the third material layer are formed of a highly reflective white thermal polymer material.

11. The lighting apparatus of claim 1, wherein the thermal conductivity of the crystalline-graphitic-carbon of the second material is at least 200 W/m-K.

12. The lighting apparatus of claim 1, wherein the thermal conductivity of the crystalline-graphitic-carbon of the second material is at least 500 W/m-K.

13. The lighting apparatus of claim 1, wherein the thermal conductivity of the crystalline-graphitic-carbon of the second material is at least 1000 W/m-K.

14. The lighting apparatus of claim 1, wherein the first material layer is formed of a plastic or other polymer material.

15. The lighting apparatus of claim 1, wherein the LEDs are laminated with the second material layer.

16. A method for forming a heat sink fin of a heat sink of the lighting apparatus, the method comprising:
forming a one or more heat sink components of a first material layer;
forming a second material layer at a surface of the first material layer, the second material layer comprising a crystalline-graphitic-carbon-based thermal optical element and a highly reflective optical coating, combined together; and
laminating the second material layer onto the first material layer.

17. The method of claim 16, wherein the highly reflective optical coating comprises a polymer binder.

18. The method of claim 16, further comprising:
forming a third material layer of a thermal polymer material on the second material layer.

19. The method of claim 18, further comprising:
intrinsically laminating the second material layer between the first material layer and the third material layer.

20. The method of claim 16, further comprising:
laminating LEDs of the lighting apparatus with the second material layer.

21. The method of claim 16, wherein the second material layer is continuously laminated along a surface area of the first material layer.

22. The method of claim 16, wherein the thermal conductivity of the crystalline-graphitic-carbon of the second material layer ranges from approximately 600 W/m-K to approximately 1200 W/m-K.

23. The method of claim 16, wherein the first material layer is formed of a plastic or other polymer material.
